(19) United States
(12) Patent Application Publication
(10) Pub. No.: US 2025/0091910 A1
(43) Pub. Date: Mar. 20, 2025

(54) WATER SOFTENING EQUIPMENT AND REGENERATION SYSTEM THEREOF

(71) Applicant: KEMFLO INTERNATIONAL CO., LTD., Pingtung City (TW)

(72) Inventors: Sheng-Nan LIN, Pingtung City (TW); Cheng-Shing LO, Pingtung City (TW)

(73) Assignee: KEMFLO INTERNATIONAL CO., LTD., Pingtung City (TW)

(21) Appl. No.: 18/612,476

(22) Filed: Mar. 21, 2024

(30) Foreign Application Priority Data
Sep. 19, 2023 (TW) 112135733

(51) Int. Cl. C02F 1/42; B01J 49/75; B01J 49/85

(52) U.S. Cl. CPC C02F 1/42; B01J 49/75; B01J 49/85; C02F 2303/16

(57) ABSTRACT

A regeneration system is provided for regenerating at least one regeneration container which has an accommodation space for confining therein an inactive ion-exchange resin. The regeneration system includes a flow-path control device, a first tank, a second tank, a first filtration element, a third tank, and a second filtration element. The flow-path control device is actuated to be operable in a first circulation state and a second circulation state. The first tank is switchable to be in fluid communication with the accommodation space. The second tank is switchable to be in fluid communication with a first circulation path. The first filtration element is disposed to filter a first liquid in the first circulation path. The third tank is switchable to be in fluid communication with the accommodation space. The second filtration element is disposed to filter a third liquid in a second circulation path.

### CROSS-REFERENCE TO RELATED APPLICATION

This application claims priority to Taiwanese Invention Patent Application No. 112135733, filed on Sep. 19, 2023, which is incorporated by reference herein in its entirety.

### FIELD

The disclosure relates to a water treatment equipment, and more particularly to a water softening equipment and a regeneration system thereof.

### BACKGROUND

In recent years, an ion-exchange resin was often used to remove calcium ions and magnesium ions from hard water to prevent formation of mineral scale such as calcium salt or magnesium salt when heating such water, which may affect the service life of appliances such as an electric water heater. Typically, a regeneration brine, such as sodium chloride or potassium chloride, is used to regenerate the ion-exchange resin for reuse.

Referring to FIG. 1, a conventional method for regenerating an ion-exchange resin includes an introduction step 91, a substitution step 92, and a filtration and discharge step 93. In the introduction step 91, a regenerating brine containing sodium chloride is introduced into a container in which an inactive ion-exchange resin saturated with calcium ions is accommodated. In the substitution step 92, the calcium ions trapped on the inactive ion-exchange resin are substituted by sodium ions from the regenerating brine to regenerate the ion-exchange resin, thereby obtaining a brine waste (including calcium chloride) and a regenerated ion-exchange resin in the container. In the filtration and discharge step 93, the brine waste is separated from the regenerated ion-exchange resin by a filter, and discharged to external environment, so that the container with the regenerated ion-exchange resin is obtained.

It should be noted that in the substitution step 92, the substitution of the calcium ions by the sodium ions is a reversible chemical reaction. That is, after the regenerating brine is introduced into the container for substituting the calcium ions by the sodium ions from the regenerating brine, such substitution reaction will stop once a chemical equilibrium state between the calcium ions and the sodium ions is reached. Therefore, some of the calcium ions may still remain trapped on the ion-exchange resin and may not be substituted by the sodium ions from the regenerating brine. In addition, the discharged brine waste may undesirably include sodium chloride, and may cause soil salinization, thereby resulting in reduced crop yields and damage to infrastructure.

Therefore, those skilled in art strive to devise a way to carry out complete substitution of the calcium ions by the sodium ions during the regeneration process and to recycle the regenerating brine, so as to obtain a container containing a fully regenerated ion-exchange resin and to achieve zero emission for the brine wastewater.

### SUMMARY

Therefore, an object of the disclosure is to provide a water softening equipment and a regeneration system thereof that can alleviate at least one of the drawbacks of the prior art.

According to the disclosure, the regeneration system is provided for regenerating at least one regeneration container which has an accommodation space for confining therein an inactive ion-exchange resin. The regeneration system includes a flow-path control device, a first tank, a second tank, a first filtration element, a third tank, and a second filtration element. The flow-path control device is actuated to be operable in a first circulation state and a second circulation state. In the first circulation state, an accommodation liquid inside the accommodation space is driven to continuously circulate through a first circulation path which passes through the accommodation space. In the second circulation state, the accommodation liquid is driven to continuously circulate through a second circulation path which passes through the accommodation space. The first tank is switchable to be in fluid communication with the accommodation space. As such, a first liquid inside the first tank is permitted to flow into the accommodation space to serve as the accommodation liquid, and to be driven by the flow-path control device to continuously circulate through the first circulation path to force the first liquid to mix and react with the inactive ion-exchange resin that contains first cations. After the first cations on the ion-exchange resin are exchanged with second cations to obtain a regenerated ion-exchange resin in a reacted first liquid, the reacted first liquid inside the accommodation space is permitted to flow back into the first tank. The second tank is switchable to be in fluid communication with the first circulation path. As such, a second liquid, which has a regenerant salt containing the second cations in the second tank, is permitted to be introduced into the first circulation path to mix with the first liquid, and the first cations are permitted to react with the regenerant salt of the second liquid to obtain a resulting salt containing the first cations and to obtain the regenerated ion-exchange resin. The first filtration element is disposed to filter the first liquid in the first circulation path so as to collect a first portion of the resulting salt that is entrained in the first liquid. The third tank is switchable to be in fluid communication with the accommodation space. After the reacted first liquid flows back into the first tank, a third liquid inside the third tank is permitted to be introduced into the accommodation space to serve as the accommodation liquid and to be driven by the first flow-path control device to continuously circulate through the second circulation path to force the third liquid to mix with the regenerated ion-exchange resin. As such, a second portion of the resulting salt, which remains inside the accommodation space, is permitted to be entrained in the third liquid and to circulate through the second circulation path. The second filtration element is disposed to filter the third liquid in the second circulation path so as to collect the 15 second portion of the resulting salt entrained in the third liquid.

According to another aspect of the disclosure, the water softening apparatus is provided for converting a hard water into a soft water. The water softening apparatus includes the aforesaid regeneration system, and a container module including containers. Each of the containers has an accommodation space for confining therein an ion-exchange resin. A first selected one of the containers is coupled to a source of the hard water to serve as a softening container in which the ion-exchange resin is active so as to convert the hard water into the soft water. A second selected one of the containers is coupled to the regeneration system to serve as the at least one regeneration container, in which the ion-exchange resin is inactive, so as to permit the ion-exchange resin inside the at least one regeneration container to be regenerated by the regeneration system.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating a conventional method for regenerating an ion-exchange resin.

FIG. 2 is a schematic view illustrating a first embodiment of a water softening apparatus according to the present disclosure.

FIGS. 3 to 14 are schematic views illustrating different stages for performing a regeneration process, a washing process, and an electrodialysis process using a regeneration system of the first embodiment.

FIG. 15 is a schematic view illustrating a stage for performing a softening process using an active ion-exchange resin of the first embodiment.

FIG. 16 is a schematic view illustrating a stage after the stage shown in FIG. 15 and at the end of the softening process in the first embodiment.

FIG. 17 is a schematic view illustrating a second embodiment of a water softening apparatus according to the present disclosure.

FIG. 18 is a schematic view illustrating a third embodiment of a water softening apparatus according to the present disclosure.

FIGS. 19 and 25 are schematic views illustrating different stages for simultaneously performing a regeneration process in one of regeneration containers, and a washing process and an electrodialysis process in the other ones of the regeneration containers using a regeneration system of the third embodiment.

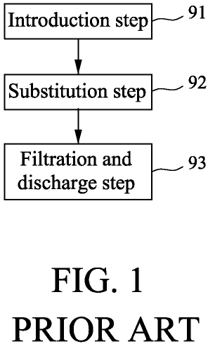

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

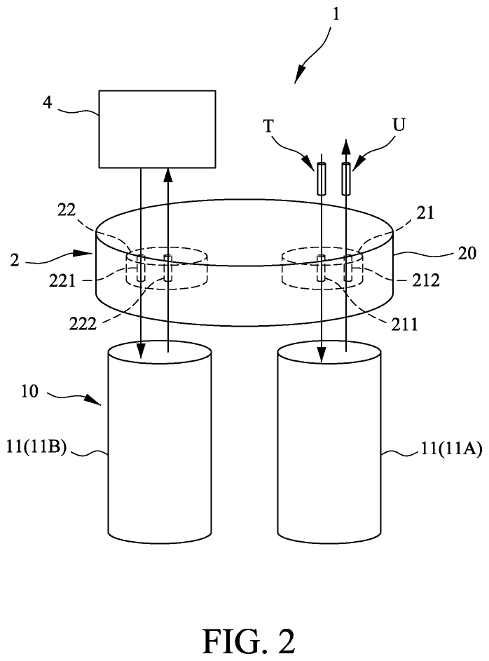

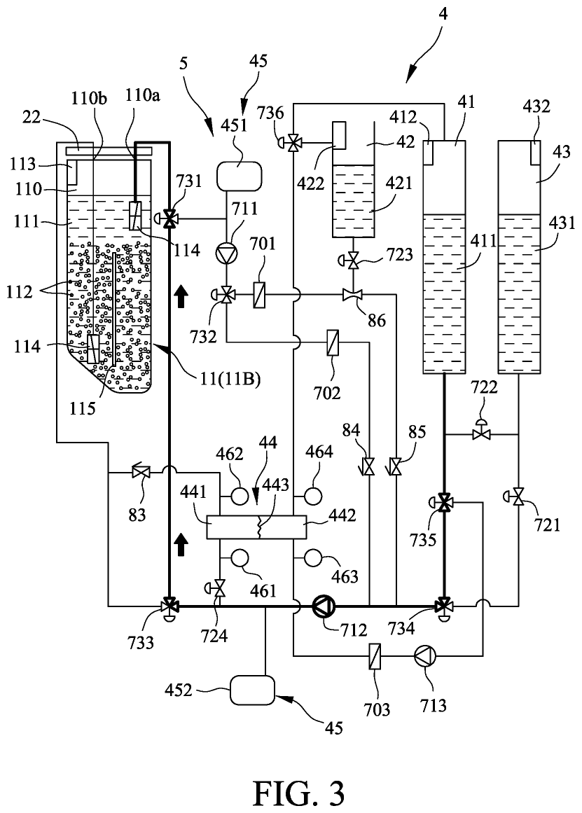

Referring to FIGS. 2 and 3, a first embodiment of a water softening apparatus 1 according to the present disclosure is provided for converting a hard water into a soft water, and includes a regeneration system 4 and a container module 10 including containers 11. Each of the containers 11 has an accommodation space 110 for confining therein an ion-exchange resin 112, a first port 110a and a second port 110b. In this embodiment, an inner sensor 113, two filter meshes 114, and a partition plate 115 may be disposed in each of the containers 11. The accommodation space 110 may be in fluid communication with an external environment through the first port 110a and/or the second port 110b. The inner sensor 113 is used to measure a hardness of the soft water and a liquid level within the accommodation space 110. The two filter meshes 114 are respectively connected to the first port 110a and the second port 110b for preventing the ion-exchange resin 112, along with an accommodation liquid 111 inside the accommodation space 110, from flowing out. The partition plate 115 is provided to guide a flow direction of the accommodation liquid 111 within the accommodation space 110, so as to facilitate the accommodation liquid 111 to mix well with the ion-exchange resin 112 and to prevent the ion-exchange resin 112 from accumulating at the bottom of the accommodation space 110.

The container(s) 11, which are connected to the regeneration system 4, serve as regeneration container(s) 11B. As such, the container module includes at least one regeneration container 11B. In the embodiment shown in FIG. 2, the container module 10 includes a single regeneration container 11B. Referring to FIGS. 3 to 6, the regeneration system 4 is provided for regenerating the regeneration container 11B in which the ion-exchange resin 112 is inactive (hereinafter referred to as inactive ion-exchange resin). The regeneration system 4 includes a flow-path control device 5, a first tank 41, a second tank 42, a first filtration element 701, a third tank 43, and a second filtration element 702. In regeneration of the regeneration container 11B, a regeneration process and a washing process are sequentially performed.

The flow-path control device 5 is configured to guide a liquid in the regeneration system 4 and the regeneration container 11B to flow in many different modes, as shown in FIGS. 3 to 14. In this embodiment, the flow-path control device includes three pumps 711, 712, 713, ten valves 721, 722, 723, 724, 731, 732, 733, 734, 735, 736, three one-way valves 83, 84, 85, a guiding element 86 and many conduits among the above components. The flow-path control device 5 is actuated to be operable in a first circulation state and a second circulation state.

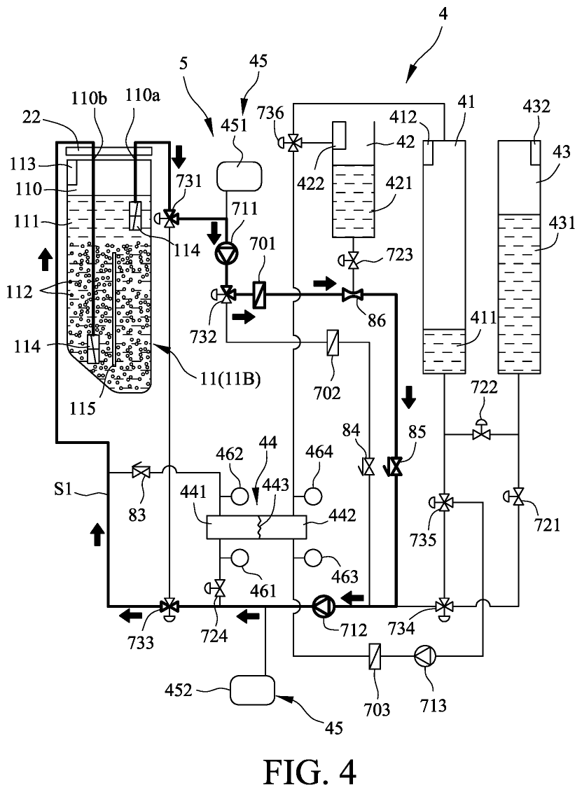

In the regeneration process, the flow-path control device 5 is mainly operated in the first circulation state. In the first circulation state, as shown in FIGS. 4 to 6, the accommodation liquid 111 is driven by the flow-path control device 5 to continuously circulate through a first circulation path S1 which passes through the accommodation space 110. In this embodiment, in the first circulation state, the pumps 711, 712 are actuated, the pump 713 and valves 723, 724, 734 are switched off, and the valves 731, 732, 733 are switched to suitable positions to permit the accommodation liquid 11 in the first circulation path S1 to flow out of the accommodate space 110 via the first port 110a, to pass through the first sensor 451, the first filtration element 701, the guiding element 86, the one-way valve 85, and the second sensor 452, and then to flow back into the accommodate space 110 via the second port 110b.

The first tank 41 includes a first liquid 411 therein and a first level gauge 412 mounted on an inner sidewall surface of the first tank 41. The first tank 41 is switchable by the flow-path control device 5 to be in fluid communication with the accommodation space 110. In this embodiment, as shown in FIG. 3, before being operated in the first circulation state (see FIGS. 4 to 6), the first liquid 411 inside the first tank 41 is permitted to flow into the accommodation space 110 to serve as the accommodation liquid 111. To be specific, at the stage shown in FIG. 3, the pump 712 is actuated, the pumps 711, 713 and the valves 722 724 are switched off, and the valves 731, 733, 734, 735 are switched to suitable positions to guide the first liquid 411 to flow into the accommodation space 110 of the regeneration container 11B via the first port 110a.

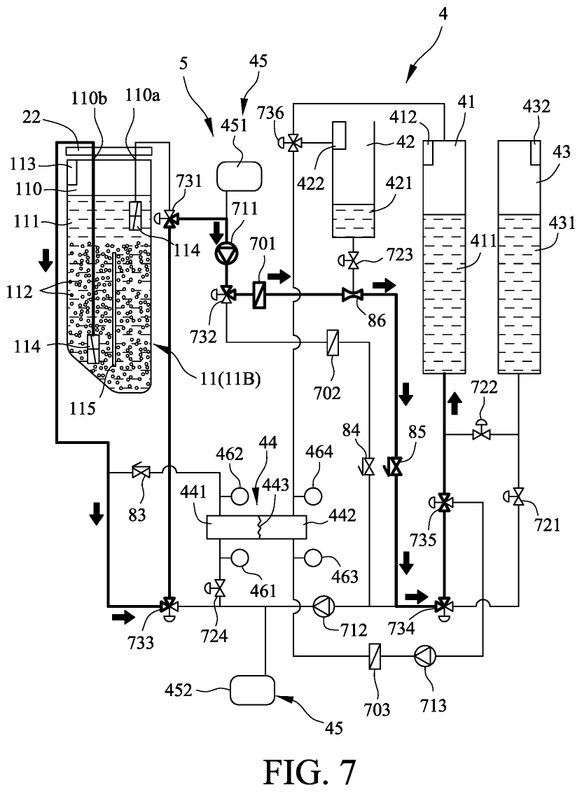

In the process for introducing the first liquid 411 into the accommodation space 110, once the liquid level of the accommodation liquid 111 within the accommodation space 110 (measured by the inner sensor 113) increases to a first predetermined level (meanwhile, a liquid level of the first liquid 411 inside the first tank 41 (measured by the first level gauge 412) decreases accordingly), the first liquid 411 is ceased to be introduced into the accommodation space 110, and the flow-path control device 5 is switched to operate in the first circulation state. In the first circulation state, the first liquid 411 serving as the accommodation liquid 111 inside the accommodation space 110 is permitted to be driven by the flow-path control device 5 to continuously circulate through the first circulation path S1 to force the first liquid 411 to mix and react with the inactive ion-exchange resin 112 that contains first cations, such as calcium ions (Ca²⁺) and magnesium ions (Mg²⁺) originating from the hard water. After the first cations on the inactive ion-exchange resin 112 are exchanged with second cations, a regenerated ion-exchange resin 112 may be obtained in a reacted first liquid, and the reacted first liquid inside the accommodation space 110 is permitted to flow back into the first tank 41, as shown in FIG. 7.

A regenerant salt containing the second cations and anions may be included in the first liquid 411 and a second liquid 421 from the second tank 42, but a concentration of the regenerant salt in the second liquid 421 is higher than that in the first liquid 411. In some cases, the first liquid 411 may be pure water, while in other cases, the first liquid may include the regenerant salt. In certain embodiments, the regenerant salt may be an alkali metal salt that has regenerative activity. In particular, the anions dissociated from the alkali metal salt are able to react with the first cations, such as calcium ions and magnesium ions, to form a resulting salt that is insoluble in water and that includes the first cations. For instance, the alkali metal salt may be sodium bicarbonate (NaHCO₃), sodium carbonate (Na₂CO₃), or sodium oxalate (Na₂C₂O₄). In some cases, during the initial stage of the first circulation state as shown in FIG. 4, only the first liquid continuously circulates through the first circulation path S1 to permit the first cations on the inactive ion-exchange resin 112 to be exchanged with the second cations in the first liquid (if any).

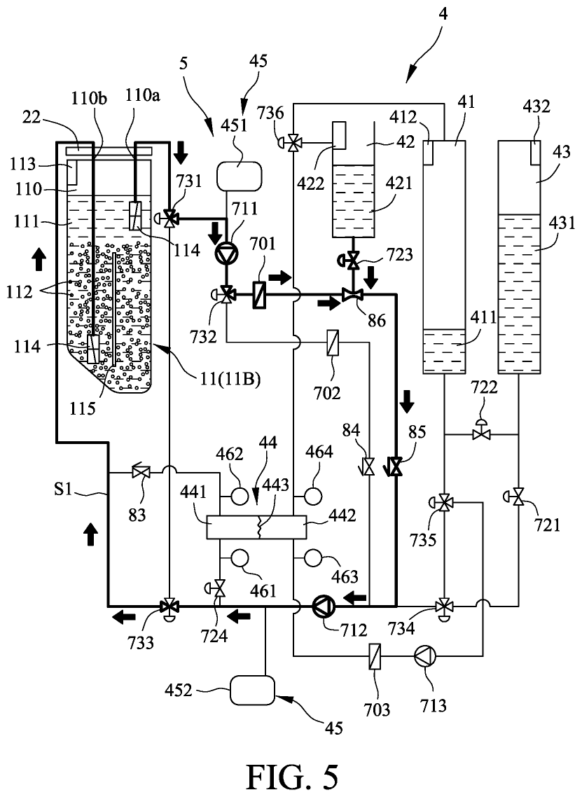

The second tank 42 includes the second liquid 421 therein and a second level gauge 422 mounted on an inner sidewall surface of the second tank 42. In the first circulation state, the second tank 42 is switchable by the flow-path control device 5 to be in fluid communication with the first circulation path S1. As such, the second liquid 421 is permitted to be introduced into the first circulation path S1 to mix with the first liquid 411 as shown in FIG. 5, so that the first cations are permitted to react with the regenerant salt in the second liquid 421 (and also to react with the regenerant salt in the first liquid 411) to obtain the resulting salt and the regenerated ion-exchange resin 112. To be specific, as shown in FIG. 5, the flow-path control device 5 is operated in the first circulation state and the valve 723 is opened, so that the second liquid 421 is introduced into the first circulation path S1 through the guiding element 86. The guiding element 86 is disposed to introduce the second liquid 421 into the first circulation path S1, and is in the form of a venture tube so as to guide the second liquid 421 to flow into the first circulation path S1 along the arrows shown in FIG. 5. In some cases, the second liquid 421 may be introduced into the first circulation path S1 for every predetermined time interval, while in other cases, the second liquid 421 may be introduced into the first circulation path S1 based on total dissolved salt concentration and/or the concentration of the first cations in the first liquid continuously circulating through the first circulation path S1.

In this embodiment, the regeneration system 4 further includes a sensor unit 45 disposed on the first circulation path S1 for measuring a concentration of the first cations in any liquid in the first circulation path S1. Once the concentration of the first cations is higher than a first predetermined value, the valve 723 is switched on to permit a predetermined amount of the second liquid 421 in the second tank 42 to be introduced into the first circulation path S1 to mix with the first liquid.

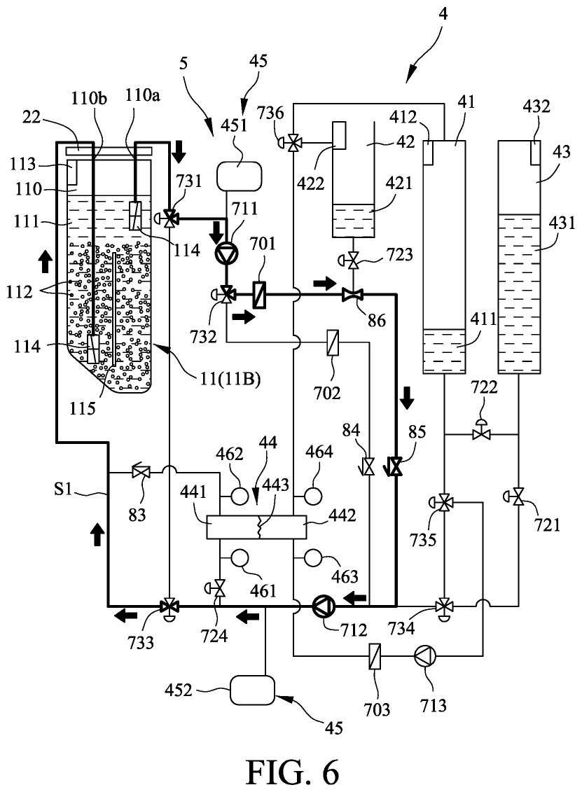

In the embodiment shown in FIGS. 4 to 6, the sensor unit 45 includes a first sensor 451 and a second sensor 452. The first liquid continuously circulates through the first circulation path S1 for many cycles. In each cycle, the first sensor 451 is disposed to detect the concentration of the first cations in the first liquid 411 before addition of the regenerant salt, and the second sensor 452 is disposed to detect the concentration of the first cations of the first liquid 411 in the first circulation path S1 after addition of the regenerant salt, if any. Once the concentration of the first cations measured by the first sensor 451 is higher than the first predetermined value, the second liquid 421 is introduced into the first circulation path S1 (see FIG. 5). In addition, once the concentration of the first cations measured by the second sensor 452 is lower than a second predetermined value, the valve 723 is switched off, and the flow-path control device 5 is continuously operated in the first circulation state, as shown in FIG. 6 (i.e., a mixture of the first liquid and the introduced second liquid is circulated in the first circulation path S1), to permit the second cations in the introduced second liquid to exchange with the first cations on the inactive ion-exchange resin 112.

The first filtration element 701 is disposed to filter the first liquid 411 (or the mixture of the first liquid and the introduced second liquid) in the first circulation path S1 so as to collect a first portion of the resulting salt that is entrained in the first liquid 411 (i.e., the accommodation liquid 111), as shown in FIGS. 4 to 6.

In the process of the first liquid 411 being guided to continuously circulate through the first circulation path S1 as shown in FIG. 6, once a concentration of the first cations in the reacted first liquid (measured by the first and/or second sensor 451, 452) is lower than a third predetermined value, the reacted first liquid inside the accommodation space 110 is permitted to flow back into the first tank 41, as shown in FIG. 7. To be specific, at the stage shown in FIG. 7, the pump 711 is actuated, the pumps 712, 713 and the valves 722, 723 are switched off, and the valves 731, 732, 733, 734, 735 are switched to suitable positions to permit the reacted first liquid inside the accommodation space 110 to flow out of the accommodate space 110 via the second port 110b, to pass through the first filtration element 701, the guiding element 86, and the one-way valve 85, and then to flow back into the first tank 41. Once a liquid level of the reacted first liquid within the first tank 41 (measured by the first level gauge 412) reaches a second predetermined level (meanwhile, the liquid level of the accommodation liquid 111 within the accommodation space 110 (measured by the inner sensor 113) decreases accordingly), the reacted first liquid is ceased to flow back into the first tank 41 and the regeneration process is completed. After the regeneration process, the ion-exchange resin 112 inside the regenerated container 11B may also be referred to as regenerated ion-exchange resin.

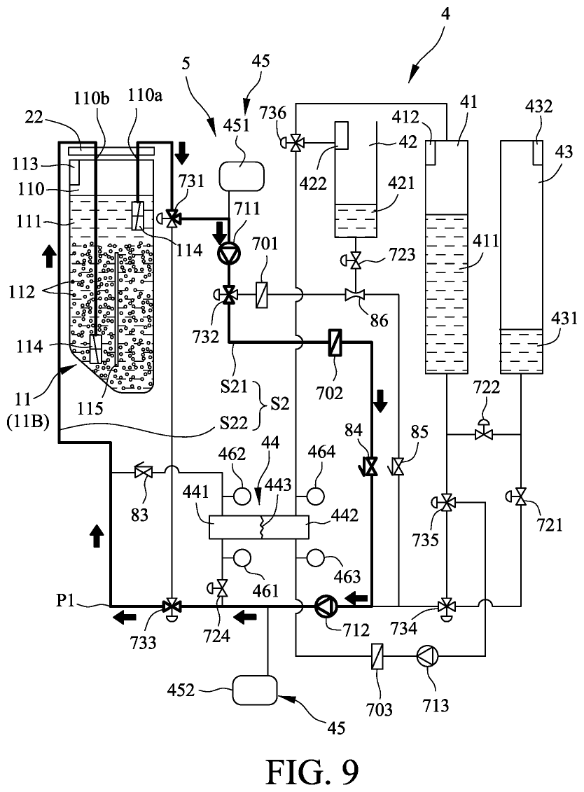

In the washing process, the flow-path control device 5 is mainly operated in the second circulation state. In the second circulation state, as shown in FIG. 9, the accommodation liquid 111 is driven by the flow-path control device 5 to continuously circulate through a second circulation path S2 which passes through the accommodation space 110. In this embodiments, in the second circulation state, the pumps 711, 712 are actuated, the pump 713 and the valves 724, 734 are switched off, and the valves 731, 732, 733 are switched to suitable positions to permit the accommodation liquid 11 in the second circulation path S2 to flow out of the accommodate space 110 via the first port 110a, to pass through the second filtration element 702 and the one-way valve 84, and then to flow back into the accommodate space 110 via the second port 110b.

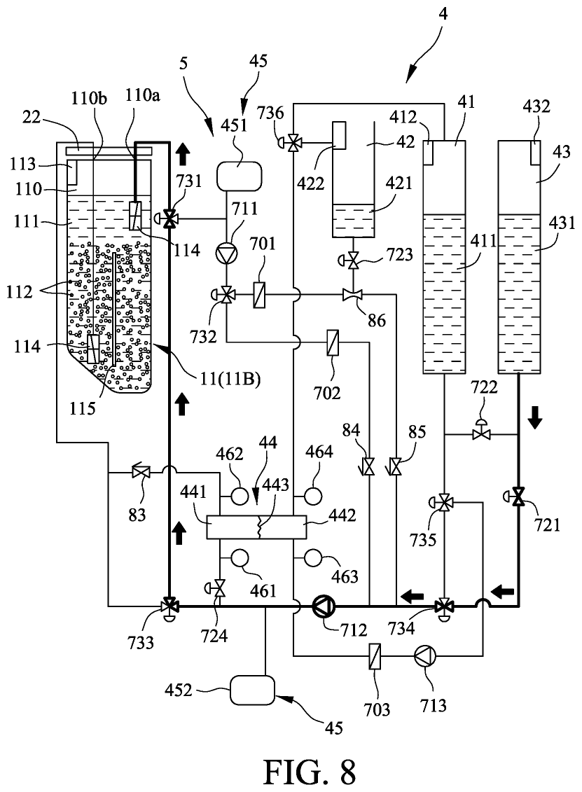

The third tank 43 includes a third liquid 431 therein and a third level gauge 432 mounted on an inner sidewall surface of the third tank 43. The third tank 43 is switchable by the flow-path control device 5 to be in fluid communication with the accommodation space 110. In this embodiment, as shown in FIG. 8, after the reacted first liquid flows back into the first tank 41 (see FIG. 7), and before the flow-path control device 5 is operated in the second circulation state (see FIG. 9), the third liquid 431 inside the third tank 43 is permitted to be introduced into the accommodation space 110 to serve as the accommodation liquid 111. To be specific, at the stage shown in FIG. 8, the pump 712 is actuated, the pumps 711, 713 and the valves 722, 724, 735 are switched off, and the valves 721, 731, 733, 734 are switched to suitable positions to guide the third liquid 431 to flow into the accommodation space 110 of the regeneration container 11B via the first port 110a. Once the third liquid 431, pressurized by the pump 712, is introduced into the accommodation space 110 through the first port 110a, the regenerated ion-exchange resin 112 accumulated around the filter mesh 114 that is connected to the first port 110 and at the bottom of the accommodation space 110 may be flushed by the pressurized third liquid.

In the process of the third liquid 431 being guided into the accommodation space 110, once the liquid level of the accommodation liquid 111 within the accommodation space 110 (measured by the inner sensor 113) increases to a third predetermined level (meanwhile, a liquid level of the third liquid 431 inside the third tank 43 (measured by the third level gauge 432) decreases accordingly), the third liquid 431 serving as the accommodation liquid 111 inside the accommodation space 110 is permitted to be driven by the flow-path control device to continuously circulate through the second circulation path S2 to force the third liquid 431 to mix with the regenerated ion-exchange resin 112, as shown in FIG. 9. As such, the regenerated ion-exchange resin 112 at the bottom of the accommodation space 110 and accumulated around the filter mesh 114 that is connected to the second port 110b can be flushed upwardly by the third liquid 431, thereby preventing the regenerated ion-exchange resin 112 from blocking the second port 110b, and achieving a backwashing effect. In addition, the regenerant salt and a second portion of the resulting salt, which remain inside the accommodation space 110 and which are flushed by the third liquid 431, are permitted to be entrained in the third liquid 431 and to circulate through the second circulation path S2.

In the second circulation state, as shown in FIG. 9, the second circulation path S2 includes a flow-out path portion S21 for guiding the third liquid 431 to flow out from the first port 110a of the regeneration container 11B, and a flow-back path portion S22 connected to the flow-out path portion S21 at a first location P1 for guiding the third liquid 431 (i.e., the accommodation liquid 111) to flow back to the second port 110b of the regeneration container 11B.

The second filtration element 702 is disposed to filter the third liquid 431 in the second circulation path S2 so as to collect the second portion of the resulting salt entrained in the third liquid 431, as shown in FIG. 9.

In this embodiment, after the washing process, an electrodialysis process may be further performed and the flow-path control device 5 is further switchable to be operated in a third circulation state. In the process of the third liquid 431 being guided to continuously circulate through the second circulation path S2 as shown in FIG. 9, once a concentration of the anions of the regenerant salt (i.e., bicarbonate (HCO₃²⁻), carbonate (CO₃²⁻), or oxalate (C₂O₄²⁻)) in the second circulation path S2 (measured by the first sensor 451 and/or the second sensor 452) is higher than a fourth predetermined value, but is lower than that in the second liquid 421 remaining in the second tank 42, the flow-path control device is switched to the third circulation state. In the electrodialysis process, the flow-path control device 5 is mainly operated in the third circulation state.

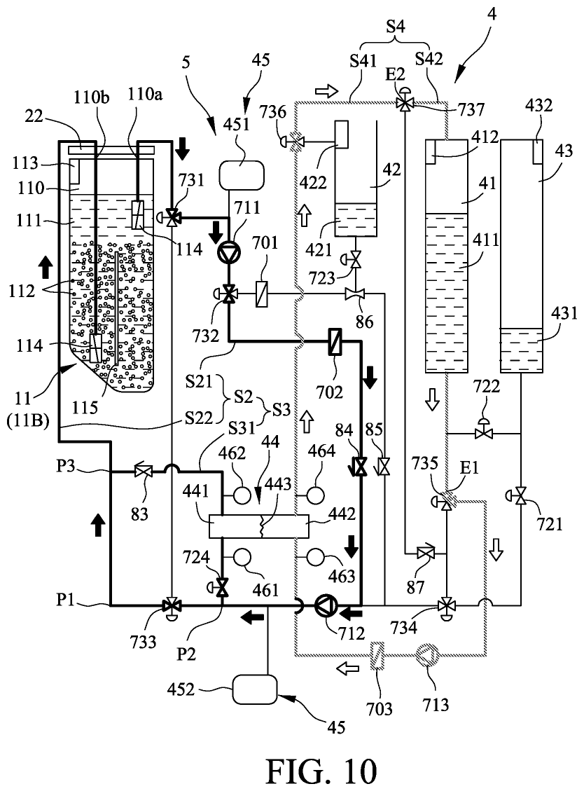

In the third circulation state, as shown in FIG. 10, the accommodation liquid 111 (i.e., the third liquid 431) is driven by the flow-path control device 5 to continuously circulate through a third circulation path S3 which passes through the accommodation space 110, and the reacted first liquid inside the first tank 41 is driven by the flow-path control device 5 to continuously circulate through a fourth circulation path S4. The third circulation path S3 includes the second circulation path S2 and a branch path portion S31. The branch path portion S31 has two opposite ends, one of which is connected to the flow-out path portion S21 at a second location P2, and the other of which is connected to the flow-back path portion S22 at a third location P3. The first location P1 is located between the second location P2 and the third location P3. The fourth circulation path S4 includes a main path portion S41 and a pass-through path portion S42 which passes through an inner space of the first tank 41 to interconnect a first end E1 and a second end E2 of the main path portion S41. The first end E1 is proximate to an outlet of the first tank 41 and the second end E2 is proximate to an inlet of the first tank 41.

In this embodiment, the regeneration system 4 further includes a third filtration element 703. The third filtration element 703 is disposed to filter the reacted first liquid in the main path portion S41 of the fourth circulation path S4 so as to collect a third portion of the resulting salt, which remains in the reacted first liquid, as shown in FIGS. 10 to 12.

In this embodiment, the regeneration system 4 further includes an electrodialyzer 44 that is disposed outside the first tank 41, the second tank 42, the third tank 43, and the regeneration container 11B. The electrodialyzer 44 includes the first chamber 441, the second chamber 442, and an ion-exchange membrane 443. The first chamber 441 is provided for passage of the third liquid 431 flowing through the branch path portion S31 of the third circulation path S3. The second chamber 442 is provided for passage of the reacted first liquid in the main path portion S41 of the fourth circulation path S4. The ion-exchange membrane 443 is disposed to separate the first chamber 441 and the second chamber 442 from each other. When the flow-path control device 5 is actuated to drive a remaining part of the regenerant salt that remains in the accommodation space 110 and that is entrained in the third liquid 431 to flow into the first chamber 441, the remaining part of the regenerant salt is forced by the electrodialyzer 44 to pass through the ion-exchange membrane 443 to flow into the second chamber 442 and to flow along the fourth circulation path S4 with the reacted first liquid.

To be specific, in the third circulation state, the pumps 711, 712, 713 are actuated, the valves 722, 734 are switched off, and the valves 724, 731, 732, 733, 735, 736 are switched to suitable positions. As such, the accommodation liquid 111 (i.e., the third liquid 431) in the third circulation path S3 is permitted to flow out of the accommodate space 110 via the first port 110a, to pass through the second filtration element 702, and the one-way valve 84, and then to flow back into the accommodate space 110 via the second port 110b. A part of the accommodation liquid 111 at the location P2 flows through the location P1 to the location P3, and the other part of the accommodation liquid 111 at the location P2 flows through the first pressure sensor 461, the first chamber 441 of the electrodialyzer 44, the second pressure sensor 462, and the one-way valve 83 and back to the location P3. Meanwhile, the reacted first liquid in the fourth circulation path S4 is permitted to flow out of the first tank 41 via the outlet near the first end E1, to pass through the third filtration element 703, the second chamber 442, and then to flow back into the first tank 41 via the inlet near the second end E2.

Although a concentration of the regenerant salt in the accommodation liquid 111 (i.e., the third liquid 431) that passes through the first chamber 441 is lower than a concentration of the regenerant salt in the reacted first liquid that passes through the second chamber 442, the electrodialyzer 44 provides a driving force to cause the remaining part of the regenerant salt to flow from the first chamber 441 into the second chamber 442, and then the remaining part of the regenerant salt is driven by the pump 713 and flows along the fourth circulation path S4. As such, the regenerant salt, which is not reacted in the regeneration process and remains in the accommodation space 110, can be fully recycled through the washing and electrodialysis processes, and thus a zero emission of the regenerant salt can be achieved.

In this embodiment, the regeneration system 4 further includes a first pressure sensor unit and a second pressure sensor unit. The first pressure sensor unit includes a first pressure sensor 461 and a second pressure sensor 462, which are disposed to detect a pressure difference of the third liquid 431 in the branch path portion S31 before and after flowing through the first chamber 441. The second pressure sensor unit includes a third pressure sensor 463 and a fourth pressure sensor 464, which are disposed to detect a pressure difference of the reacted first liquid in the main path portion S41 before and after flowing through the second chamber 442. A pressure inside the first chamber 441 (referred to as first pressure) can be determined based on two pressure values detected by first and second pressure sensors 461, 462 in the branch path portion S31, and a pressure inside the second chamber 442 (referred to as second pressure) can be determined based on two pressure values detected by third and fourth pressure sensors 463, 464 in the main path portion S41. When a pressure difference between the first and second pressures is exceedingly large (e.g., greater than an upper limit value), which may be caused by a difference in concentration of the regenerant salt between the first chamber 441 and the second chamber 442, the pump 713 is stopped from actuating, so as to prevent the electrodialyzer 44 from being damaged due to such exceedingly large pressure difference.

In addition, by virtue of switching the valve 733 to a suitable position, in each cycle of the accommodation liquid 111 (i.e., the third liquid 431) in the third circulation path S3, after the third liquid 431 in the flow-out path portion S21 reaches the second location P2, the third liquid 431, in a volume of 70%, flows through the branch path portion S31, and the third liquid 431, in a volume of 30%, flows through the flow-back path portion S22. By this way, a flow load of the electrodialyzer 44 can be effectively reduced, thereby prolonging a service life of the electrodialyzer 44.

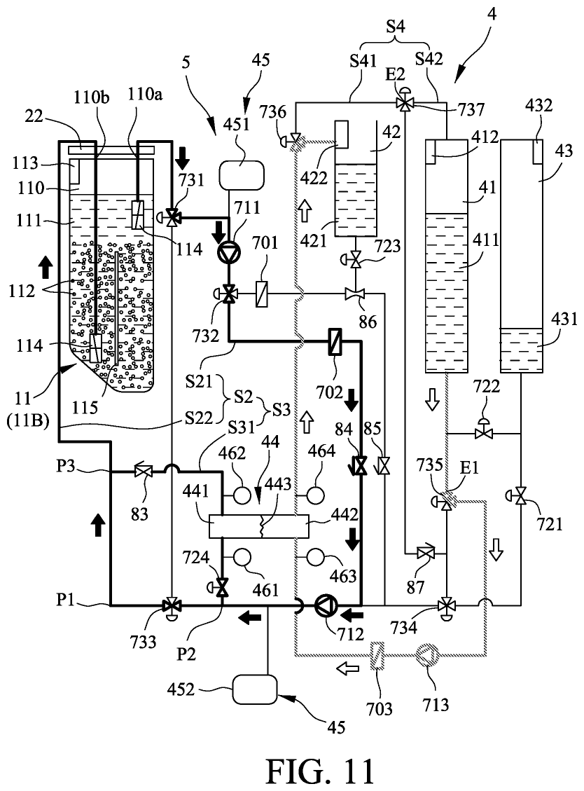

During the electrodialysis process (see FIG. 10), some of water molecules of the third liquid 431 flowing into the first chamber 441 may also be forced by the electrodialyzer 44 to pass through the ion-exchange membrane 443 to flow into the second chamber 442 along with the regenerant salt. As such, an amount of the reacted first liquid (further including the liquid from the third liquid) circulating through the fourth circulation path S4 is increased, and thus the liquid level of the reacted first liquid inside the first tank 41 is raised, which may cause overflowing of the reacted first liquid from the first tank 41. In order to prevent overflowing of the reacted first liquid from the first tank 41, in some cases, once the liquid level of the reacted first liquid inside the first tank 41 (measured by the first level gauge 412) reached a fourth predetermined level, a part of the reacted first liquid is introduced into the second tank 42, as shown in FIG. 11. To be specific, in the state shown in FIG. 11, the flow-path control device 5 is operated in the third circulation state except that the valve 736 is switched in different position to introduce the part of the reacted first liquid into the second tank 42. In other cases, once the liquid level of the reacted first liquid inside the first tank 41 (measured by the first level gauge 412) reached the fourth predetermined level, the flow-path control device 5 is further switchable to be operated in a fourth circulation state.

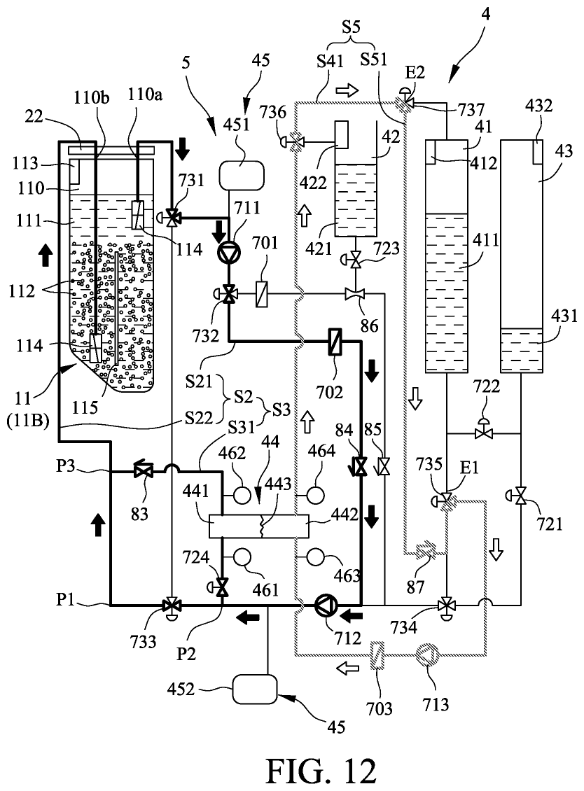

In the fourth circulation state, as shown in FIG. 12, the flow-path control device 5 further includes a valve 737 and a one-way valve 87. The accommodation liquid 111 is driven by the flow-path control device 5 to continuously circulate through the third circulation path S3 which passes through the accommodation space 110, and the reacted first liquid in the fourth circulation path S4 is driven by the flow-path control device 5 to continuously circulate through a fifth circulation path S5 without passing through the inner space of the first tank 41. The fifth circulation path S5 includes the main path portion S41 of the fourth circulation path S4, and a bypass path portion S51 which is located outside the first tank 41 to interconnect the first end E1 and the second end E2 of the main path portion S41. To be specific, for the fifth circulation path S5, the pump 713 is actuated, and the valves 735, 736, 737 are switched to suitable positions to permit the reacted first liquid previously circulating in the main path portion S41 of the fourth circulation path S4 to continuously circulate through a fifth circulation path S5 and pass through the third filtration element 703, the third pressure sensor 463, the electrodialyzer 44, the fourth pressure sensor 464, and the one-way valve 87.

In addition, the reacted first liquid in the main path portion S41 of the fourth circulation path S4 may be occasionally introduced into the second tank 42 (see FIG. 11), and occasionally circulated through the fifth circulation path S5 (see FIG. 12).

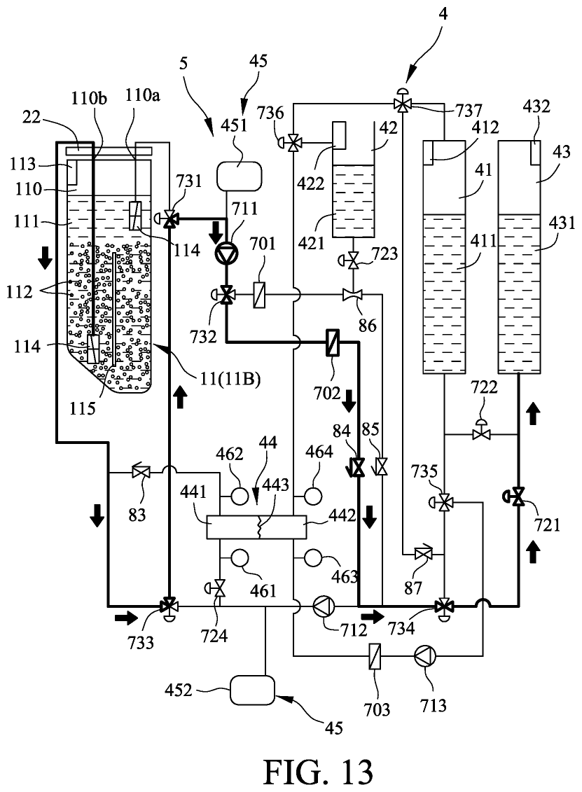

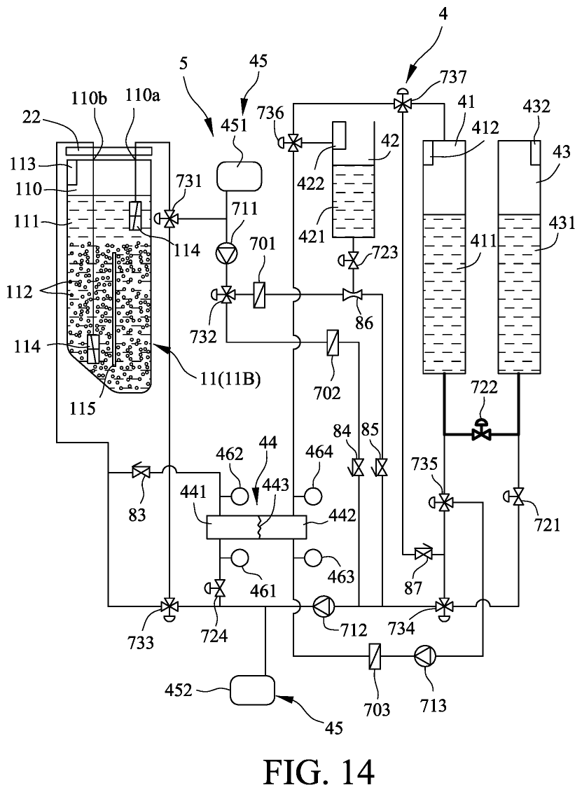

The third liquid 431 serving as the accommodation liquid 111 inside the accommodate space 110 is permitted to flow back into the third tank 43 as shown in FIG. 13 after performing the electrodialysis process for a predetermined period of time. To be specific, at the stage shown in FIG. 13, the pump 711 is actuated, the pumps 712, 713 and the valves 722, 724, 735 are switched off, and the valves 721, 731, 732, 733, 734 are switched to suitable positions to permit the accommodation liquid 111 to flow out of the accommodate space 110 via the second port 110b, to pass through the second filtration element 702, and the one-way valve 84, and then to flow back into the third tank 43. Thereafter, in order to make the liquid level of the reacted first liquid within the first tank 41 (measured by the first level gauge 412) and the liquid level of the third liquid 431 within the third tank 43 (measured by the third level gauge 432) to be at the same level, the valves 721, 735 are switched off, and the valve 722 is opened to permit the reacted first liquid and the third liquid 431 to balance out to the same level in the first tank 41 and the third tank 43 based on the principle of Communicating Vessels as shown in FIG. 14. After this stage, the electrodialysis process is completed and a renewed container, in which the ion-exchange resin 112 is active, is obtained.

Referring back to FIG. 2, in addition to the regeneration container 11B, the containers 11 of the container module 10 includes a single softening container 11A. The softening container 11A may be the renewed container in which the ion-exchange resin 112 is regenerated and active, or a new container in which the ion-exchange resin 112 is not yet used for water softening. A first selected one of the containers 11 is coupled to a source of the hard water and is disposed downstream of a hard water inlet (T) (i.e., the source of the hard water) and upstream of a soft water outlet (U) to serve as the softening container 11A, in which the ion-exchange resin 112 is active, so as to convert the hard water into the soft water. A second selected one of the containers 11 is coupled to the regeneration system 4 to serve as the regeneration container 11B, in which the ion-exchange resin 112 is inactive, so as to permit the ion-exchange resin 112 inside the regeneration container 11B to be regenerated by the regeneration system 4. After the ion-exchange resin 112 in the first selected one of the containers 11 becomes inactive, the first selected one of the containers 11 serves as the regeneration container 11B. After the ion-exchange resin 112 in the second selected one of the containers 11 becomes active, the second selected one of the containers 11 serves as the softening container 11A.

In this embodiment, the water softening apparatus 1 further includes a connection module 2 having a first connector 21, a second connector 22, and a retaining body 20. The first connector 21 is switchable to be coupled to the softening container 11A. The second connector 22 is switchable to be coupled to the regeneration container 11B. The retaining body 20 is configured to retain the first connector 21 and the second connector 22 thereinside, and is turnable relative to the container module 10 between a first position and a second position. In the first position, the first connector 21 couples with the first selected one of the containers 11 which serves as the softening container 11A, and the second connector 22 couples with the second selected one of the containers 11, which serves as the regeneration container 11B. In the second position, the first connector 21 couples with the second selected one of the containers 11 which serves as the softening container 11A, and the second connector 22 couples with the first selected one of the containers 11 which serves as the regeneration container 11B.

In addition, the first connector 21 includes a first passage 211 and a second passage 212. The first passage 211 is configured to introduce the hard water from the hard water inlet (T) into the accommodation space 110 of the softening container 11A so as to permit the hard water to be converted by the ion-exchange resin 112 of the softening container 11A into the soft water, and the second passage 212 is configured to guide the soft water from the softening container 11A to flow outwards to the soft water outlet (U).

In the embodiment, a substitution reaction that occurs during the conversion of the hard water into the soft water is represented by Scheme 1:

Hard water (containing Ca²⁺/Mg²⁺)+Resin (containing 2Na⁺)→Soft water (containing 2Na⁺)+Resin (containing Ca²⁺/Mg²⁺) (1)

The second connector 22 includes a third passage 221 and a fourth passage 222. The third passage 221 is configured to connect the regeneration system 4 and the second port 110b of the regeneration container 11B so as to permit the accommodation space 110 of the regeneration container 11B to be in fluid communication with the external environment through the second port 110b, and the fourth passage 222 is configured to connect the regeneration system 4 and the first port 110a of the regeneration container 11B so as to permit the accommodation space 110 of the regeneration container 11B to be in fluid communication with the external environment through the first port 110a.

In this embodiment, each of the containers 11 in the water softening apparatus 1 includes the inner sensor 113 which is configured to measure the hardness of the accommodation liquid 111 (e.g., soft water). Once the softening container 11A is coupled to the first connector 21, the inner sensor 113 of the softening container 11A is in signal communication with the first connector 21. In addition, the first connector 21 is permitted to be detached from the softening container 11A in response to the hardness of the soft water inside the softening container 11A reaching a fifth predetermined value as measured by the inner sensor 113.

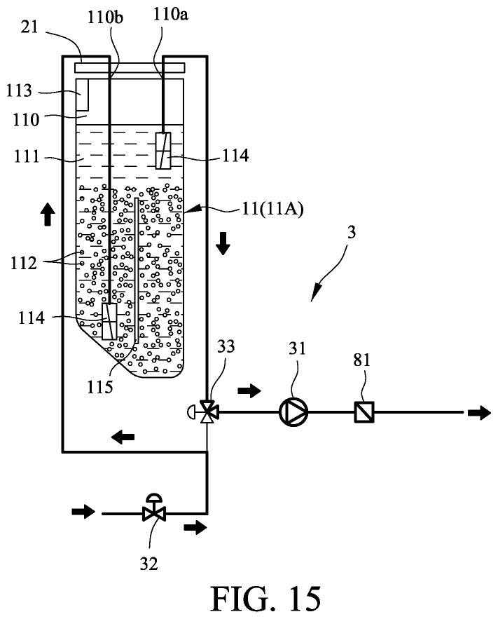

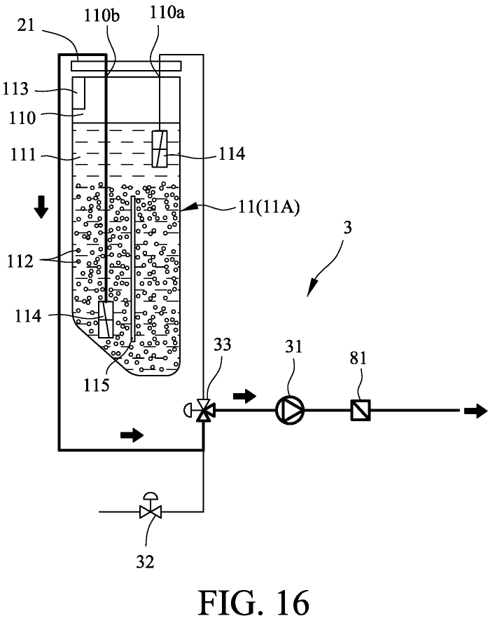

Referring to FIGS. 15 and 16, the softening container 11A, in which the ion-exchange resin 112 is active (hereinafter referred to as active ion-exchange resin), is provided for converting the hard water into the soft water. The water softening apparatus 1 further includes a driving device 3. During softening of the hard water in the softening container 11A, a softening process is performed.

The driving device 3 is configured to permit a liquid to flow into and/or out of the softening container 11A in many different modes, as shown in FIGS. 15 and 16. In this embodiment, the driving device 3 includes a pump 31, two valves 32, 33, a filter element 81, and many conduits among the above components. The filter element 81 is disposed to remove impurities entrained in the soft water.

In the softening process shown in FIG. 15, the hard water from the hard water inlet (T) is driven by the driving device 3 to be introduced into the softening container 11A through the first passage 211 (see FIG. 2), and then the thus obtained soft water is driven by the driving device 3 to flow outwards to the soft water outlet (U) through the second passage 212. To be specific, at the stage shown in FIG. 15, the pump 31 is actuated, and the valves 32, 33 are switched to suitable positions to permit the hard water from the hard water inlet (T) to flow into the softening container 11A via the second port 110b to perform the softening process, and then to permit the thus obtained soft water to be discharged from the first port 110a and to pass through the filter element 81, and then to flow outwards to the soft water outlet (U).

Once a concentration of the first cations in the soft water (measured by the inner sensor 113) is determined to be greater than the fifth predetermined value, the hard water is stopped from being introduced into the accommodation space 110 of the softening chamber 11A, and the soft water is fully discharged from the accommodation space 110, as shown in FIG. 16. To be specific, at the stage shown in FIG. 16, the pump 31 is actuated, the valve 32 is switched off, and the valve 33 is switched to a suitable position to permit all of the soft water inside the accommodation space 110 to flow out of the accommodation space 110 via the second port 110b, to pass through the filter element 81, and the second passage 212, and then to flow outwards. After this stage, the softening process is completed and the ion-exchange resin 112 in the container 11 shown in FIG. 16 becomes inactive.

In this embodiment, after the softening process is completed, the first connector 21 (see FIG. 2) is detached from the container 11, as shown in FIG. 16. Afterwards, by turning the retaining body 20 relative to the container 11, the container 11 is coupled to the second connector 22, which are coupled to the regeneration system 4.

In some embodiments, the time period for conducting each of the stages represented by FIGS. 3 to 12 and FIGS. 15 and 16 may be determined using suitable sensor(s) described above. In other embodiments, such time period may be determined based on experiments.

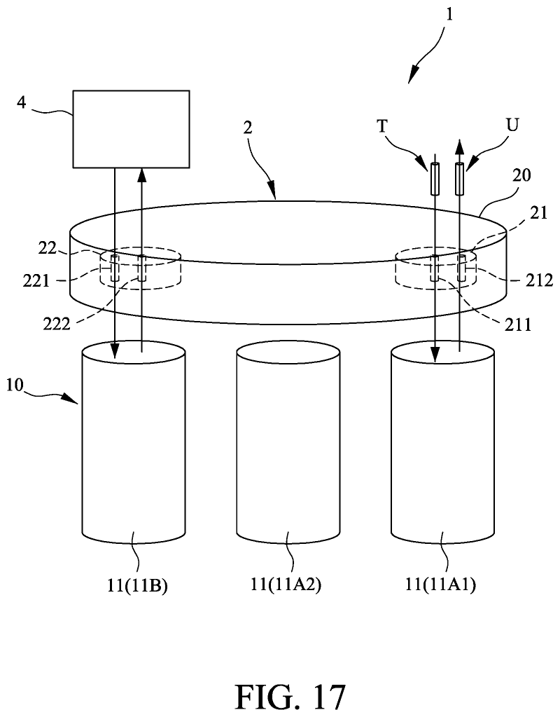

Referring to FIG. 17, a second embodiment of a water softening apparatus 1 according to the present disclosure is provided for converting the hard water into the soft water. The second embodiment is similar to the first embodiment, except that in the second embodiment, the container module 10 includes three containers 11, two of which are the softening containers 11A1, 11A2 and the other one is the regeneration container 11B. Each of the softening containers 11A1, 11A2 is sequentially subjected to the softening process. When the softening container 11A1 is subjected to the softening process, the softening container 11A2, which is a renewed container in which an ion-exchange resin is regenerated and active, is in standby for performing the softening process. As such, after the softening container 11A1 is detached from the first connector 21, the softening container 11A2 can be immediately coupled to the first connector 21.

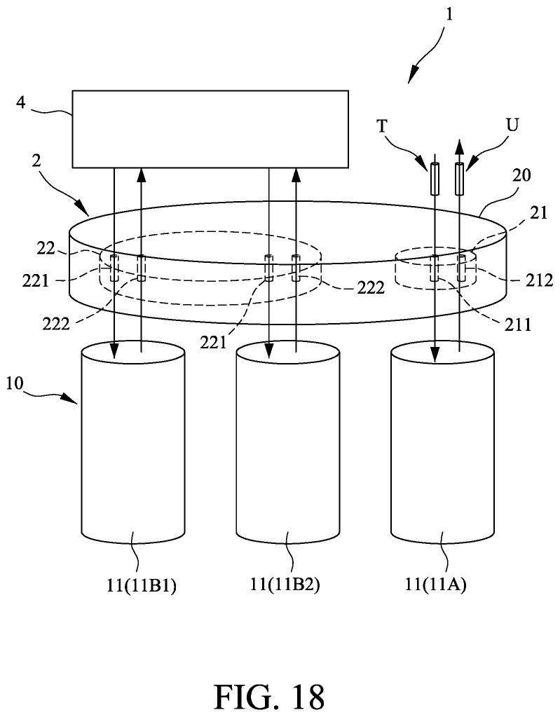

Referring to FIGS. 18 to 25, a third embodiment of a water softening apparatus 1 according to the present disclosure is provided for converting the hard water into the soft water. The third embodiment is similar to the first embodiment, except that in the third embodiment, the container module 10 includes three containers 11, one of which is the softening container 11A and the other two are the regeneration containers 11B1, 11B2, as shown in FIG. 18. Each of the regeneration containers 11B1, 11B2 is sequentially subjected to the regeneration, washing and electrodialysis processes. When the regeneration container 11B1 is subjected to the regeneration process, and the regeneration container 11B2 is subjected to the washing or electrodialysis process, significant reduction of operating time can be achieved. In addition, components of the flow-path control device 5 are rearranged to connect to the regeneration containers 11B1, 11B2. In this embodiments, the flow-path control device 5 includes four pumps 714, 715, 716, 717, sixteen valves 741, 742, 751, 752, 753, 754, 755, 756, 757, 758, 759, 761, 762, 763, 764, 765, three one-way valves 83, 84, 85, and the guiding element 86. The flow-path control device 5 is actuated to be operable in the first circulation state, the second circulation state, and the third circulation state.

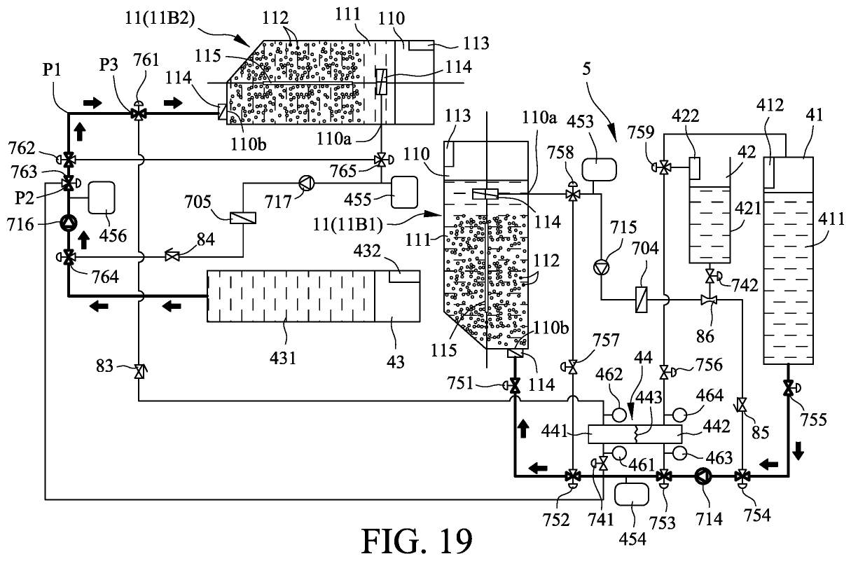

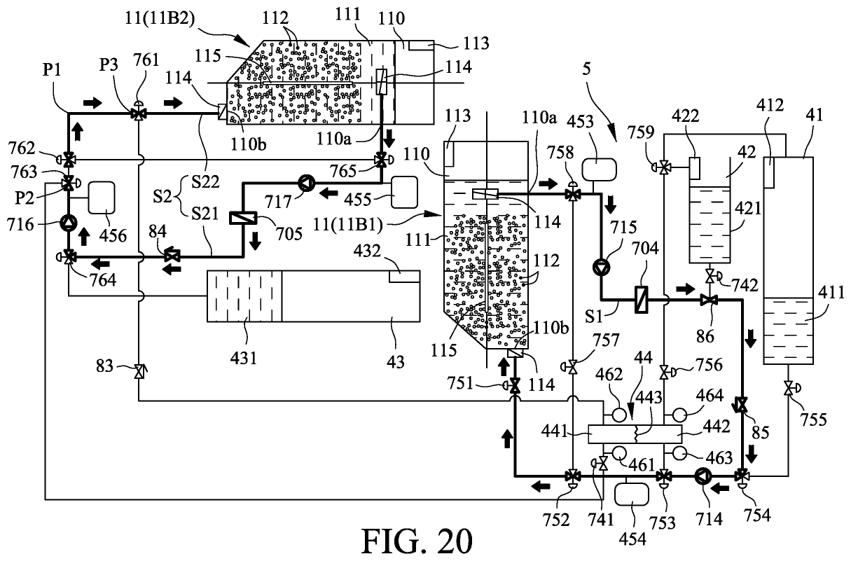

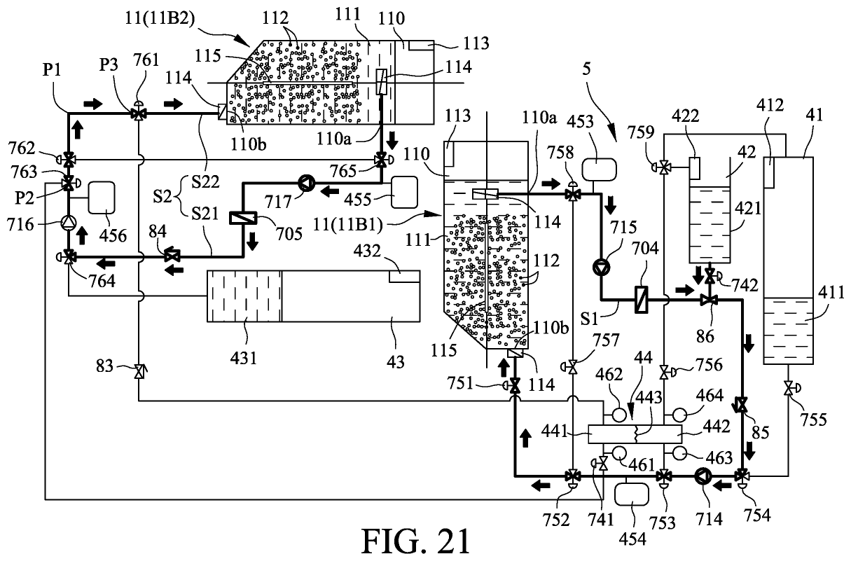

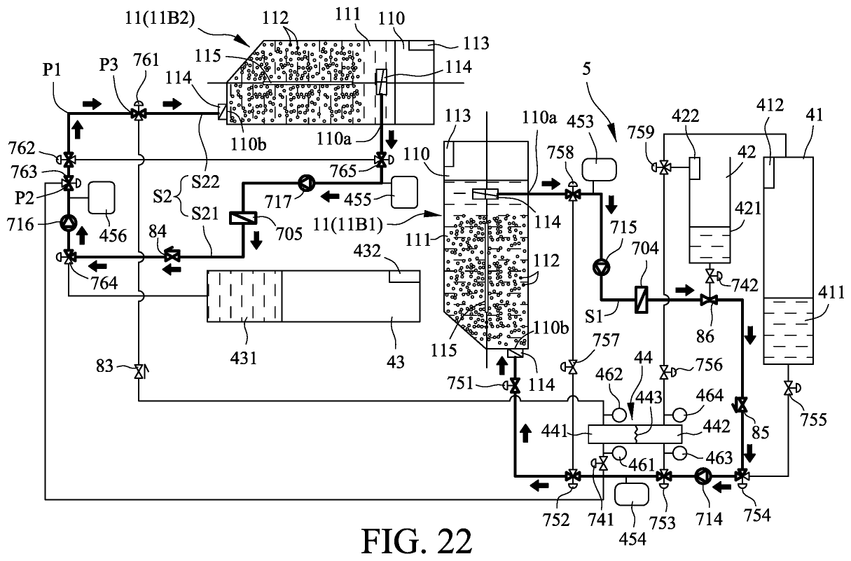

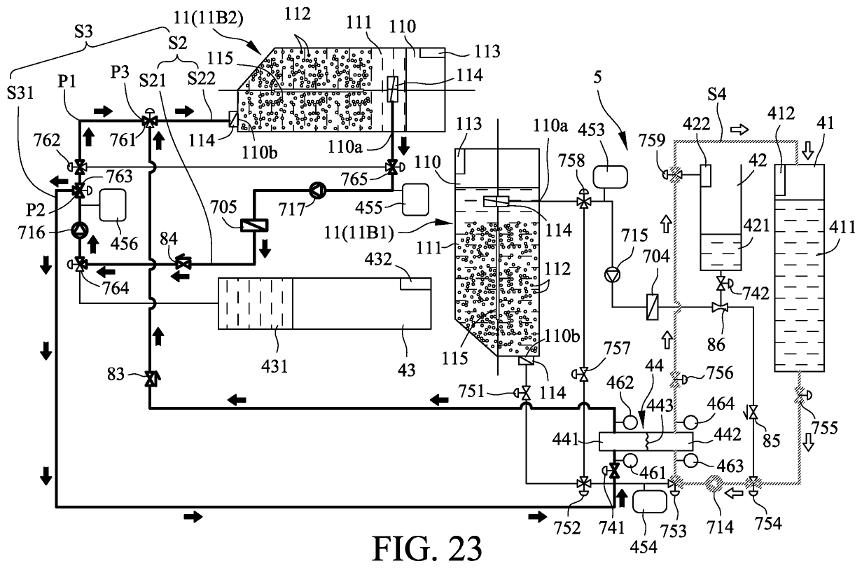

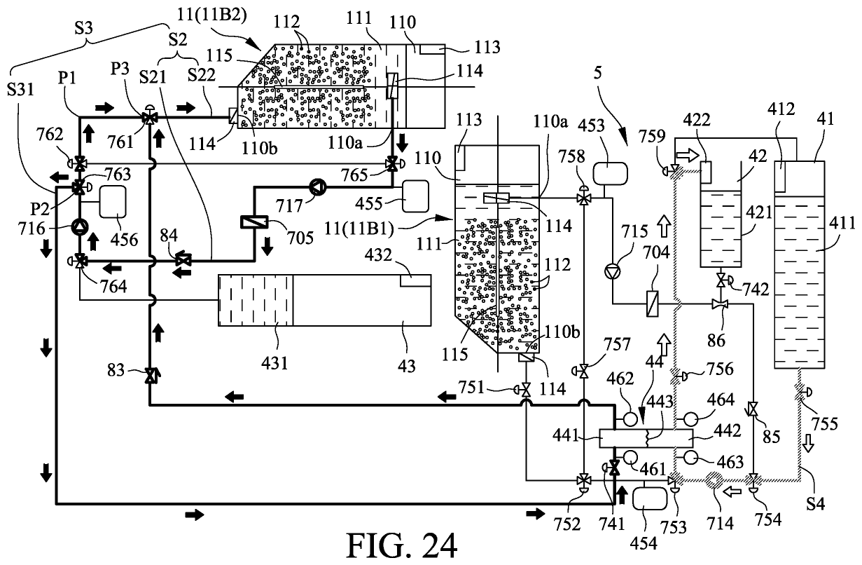

In the third embodiment, referring to FIG. 19, the regeneration container 11B1 is in the regeneration process and the regeneration container 11B2 is in the washing process. Regarding the regeneration container 11B1, a part of the first liquid 411 inside the first tank 41 is driven by the flow-path control device to flow into the accommodation space 110 of the regeneration container 11B1, so that the part of the first liquid 411 serves as the accommodation liquid 111. To be specific, the pump 714 is actuated, the pump 715 and the valve 741 are switched off, and the valves 751, 752, 753, 754, 755 are switched to suitable positions to guide the first liquid 411 to flow into the accommodation space 110 of the regeneration container 11B1 via the second port 110b. Regarding the regeneration container 11B2, the third liquid 431 inside the third tank 43 is driven by the flow-path control device 5 to be introduced into the accommodation space 110 of the regeneration container 11B2, so that the third liquid 431 serves as the accommodation liquid 111. To be specific, the pump 716 is actuated, the pump 717 and the valve 765 are switched off, and the valves 761, 762, 763, 764 are switched to suitable positions to guide the third liquid 431 to flow into the accommodation space 110 of the regeneration container 11B2 via the second port 110b.

In the third embodiment, after the stage shown in FIG. 19, the regeneration container 11B1 is in the regeneration process, the regeneration container 11B2 is in the washing process, and the flow-path control device 5 is actuated to be simultaneously operated in both the first circulation state and the second circulation state (see the stage shown in FIG. 20). The regeneration container 11B1 is connected to some components of the flow-path control device that is operated in the first circulation state, while the regeneration container 11B2 is connected to other components of the flow-path control device 5 that is operated in the second circulation state. Regarding the regeneration container 11B1, the first liquid 411 serving as the accommodation liquid 111 inside the accommodation space 110 is driven by the some components of the flow-path control device 5 that is operated in the first circulation state to continuously circulate through the first circulation path S1 to force the first liquid 411 to mix and react with the inactive ion-exchange resin 112 that contains first cations. To be specific, in the some components operated in the first circulation state, the pumps 714, 715 are actuated, the valves 741, 742 and 755, 757 are switched off, and the valves 751, 752, 753, 754, 758 are switched to suitable positions to permit the accommodation liquid 11 in the first circulation path S1 to flow out of the accommodate space 110 of the regeneration container 11B1 via the first port 110a, to pass through a third sensor 453, a fourth filtration element 704, the guiding element 86, the one-way valve 85, and a fourth sensor 454, and then to flow back into the accommodate space 110 of the regeneration container 11B1 via the second port 110b. The fourth filtration element 704 has a function similar to that of the first filtration element 701, and the third and fourth sensors 453, 454 have functions similar to those of the first and second sensors 451, 452. Regarding the regeneration container 11B2, the third liquid 431 serving as the accommodation liquid 111 inside the accommodation space 110 is driven by the other components of the flow-path control device 5 that is operated in the second circulation state to continuously circulate through the second circulation path S2 which passes through the accommodation space 110. In the second circulation state, the second circulation path S2 includes the flow-out path portion S21 for guiding the third liquid 431 to flow out from the first port 110a of the regeneration container 11B2, and the flow-back path portion S22 connected to the flow-out path portion S21 at the first location P1 for guiding the third liquid 431 to flow back to the second port 110b of the regeneration container 11B2. To be specific, in the other components operated in the second circulation state, the pumps 716, 717 are actuated, and the valves 761, 762, 763, 764, 765 are switched to suitable positions to permit the accommodation liquid 11 in the second circulation path S2 to flow out of the accommodate space 110 of the regeneration container 11B2 via the first port 110a, to pass through a fifth sensor 455, a fifth filtration element 705, the one-way valve 84, and a sixth sensor 456, and then to flow back to the accommodate space 110 of the regeneration container 11B2 via the second port 110b. The filtration element 705 has a function similar to that of the second filtration element 702, and each of the fifth and sixth sensors 455, 456 is a sensor for detecting a total dissolved salt concentration, or a concentration of the first cations or the second cations of a liquid passing therethrough.

In the third embodiment, after the stage shown in FIG. 20, the regeneration container 11B1 is in the regeneration process and the regeneration container 11B2 is in the washing process (see FIG. 21). In the regeneration process shown in FIG. 21, similar to the regeneration process shown in FIG. 5, based on the total dissolved salt concentration and/or the concentration of the first cations in the first liquid 421 (i.e., the accommodation space 110), which may be measured by the third and fourth sensors 453, 454, the second liquid 421 is permitted to be introduced into the first circulation path S1 to mix with the first liquid 411 in the first circulation state, so that the first cations are permitted to react with the regenerant salt in the second liquid 421 (in addition to react with the regenerant salt in the first liquid 411) to obtain the resulting salt and the regenerated ion-exchange resin 112. To be specific, in the regeneration process shown in FIG. 21, the valve 742 and the guiding element 86 are switched to suitable positions to guide the second liquid 421 to be introduced into the first circulation path S1. The washing process shown in FIG. 21 is substantially the same as that shown in FIG. 20. That is, during introduction of the second liquid 421 into the first circulation path S1, the washing process for the regeneration container 11B2 is continuously performed.

In the third embodiment, after the stage shown in FIG. 21, the regeneration container 11B1 is in the regeneration process and the regeneration container 11B2 is in the washing process (see FIG. 22). In the regeneration process shown in FIG. 22, similar to the regeneration process shown in FIG. 6, based on the total dissolved salt concentration and/or the concentration of the first cations in the first liquid 421 (i.e., the accommodation space 110), which may be measured by the third and fourth sensors 453, 454, the valve 742 is switched off, and the flow-path control device 5 is continuously operated in the first circulation state to permit the second cations in the mixture of the first liquid and the introduced second liquid circulated in the first circulation path S1 to be exchanged with the first cations on the inactive ion-exchange resin 112. After such exchange, a regenerated ion-exchange resin 112 may be obtained in a reacted first liquid. The washing process shown in FIG. 22 is substantially the same as that shown in FIG. 20 or 21.

In the third embodiment, after the stage shown in FIG. 22, the regeneration container 11B2 is in the electrodialysis process after the washing process for the regeneration container 11B2 is completed, and the flow-path control device 5 is operated in the third circulation state (see FIG. 23). In the third circulation state, the accommodation liquid 111 inside the regeneration container 11B2 is driven by the flow-path control device 5 to continuously circulate through the third circulation path S3 which passes through the accommodation space 110, and a remaining part of the first liquid inside the first tank 41, which remains in the first tank 41 after the stage shown in FIG. 19, is driven by the flow-path control device 5 to continuously circulate through the fourth circulation path S4 which passes through the inner space of the first tank 41. The third circulation path S3 includes the second circulation path S2 and the branch path portion S31. The branch path portion S31 has two opposite ends, one of which is connected to the flow-out path portion S21 at the second location P2, and the other of which is connected to the flow-back path portion S22 at the third location P3. The first location P1 is disposed between the second location P2 and the third location P3. To be specific, at the stage shown in FIG. 23, the pumps 714, 716, 717 are actuated, the valve 752 is switched off, and the valves 741, 753, 754, 755, 756, 759, 761, 762, 763, 764, 765 are switched to suitable positions to permit the accommodation liquid 111 in the third circulation path S3 to flow out of the accommodate space 110 of the regeneration container 11B2 via the first port 110a, to pass through the fifth sensor 455, the fifth filtration element 705, the one-way valve 84, the sixth sensor 456, and then to flow back into the accommodate space 110 of the regeneration container 11B2 via the second port 110b. A part of the accommodation liquid 111 at the location P2 flows through the location P1 to the location P3, and the other part of the accommodation liquid 111 at the location P2 flows through the first pressure sensor 461, the first chamber 441 of the electrodialyzer 44, the second pressure sensor 462, and the one-way valve 83, and then flows back to the location P3. Meanwhile, the remaining part of the first liquid 411 in the fourth circulation path S4 flows out of the first tank 41 via the outlet near the valve 755, passes through the third pressure sensor 463, the second chamber 442 of the electrodialyzer 44, and the fourth pressure sensor 464, and then flows back to the first tank 41 via the inlet near the valve 759. Similar to the stage shown in FIG. 10, in the stage shown in FIG. 23, the regenerant salt, which remains in the accommodation space 110 of the regeneration container 11B2 and which is entrained in the third liquid 431 (i.e., the accommodation liquid 111), is forced by the electrodialyzer 44 to pass through the ion-exchange membrane 443 to flow into the second chamber 442 and to flow along the fourth circulation path S4 with the remaining part of the first liquid 411.

In the third embodiment, after the stage shown in FIG. 23, the regeneration container 11B2 is in the electrodialysis process (see FIG. 24). In the electrodialysis process shown in FIG. 24, similar to the electrodialysis process shown in FIG. 11, the valve 759 is switched in different position to introduce a portion of the first liquid inside the first tank 41 (including the liquid from the first chamber 441), which is driven by the flow-path control device 5, to flow into the second tank 42 through the fourth circulation path S4. To be specific, the pump 714 is actuated, the valve 752 is switched off, and the valves 753, 754, 755, 756, 759 are switched to suitable positions to permit the portion of the first liquid in the fourth circulation path S4 to flow out of the first tank 41 via the outlet near the valve 755, to pass through the third pressure sensor 463, the second chamber 442 of the electrodialyzer 44, and the fourth pressure sensor 464, and then to flow into the second tank 42. In addition, the accommodation liquid 111 inside the regeneration container 11B2 is still driven by the flow-path control device 5 to continuously circulate through the third circulation path S3 which passes through the accommodation space 110.

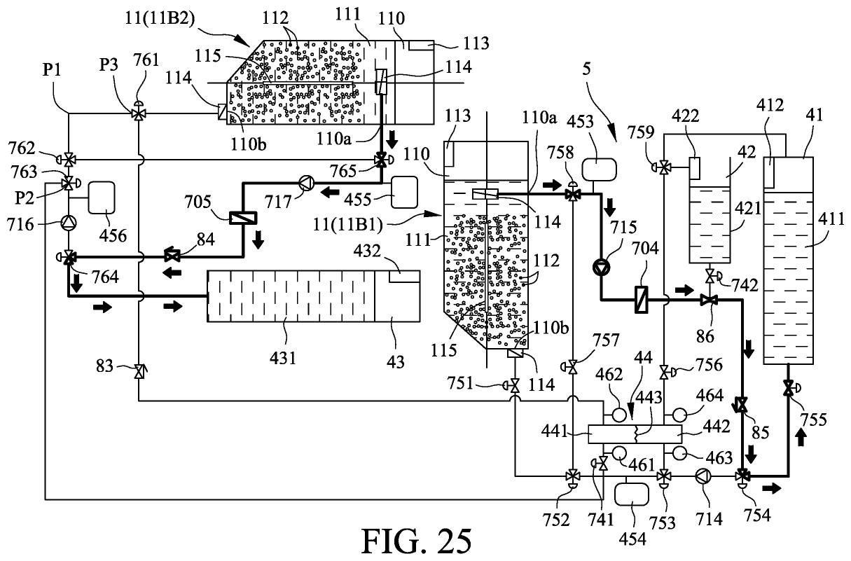

In the third embodiment, after the stage shown in FIG. 24, the reacted first liquid inside the regeneration container 11B1 is introduced back into the first tank 41, and the accommodation liquid 111 inside the regeneration container 11B2 is introduced back into the third tank 43 (see FIG. 25). To be specific, the pump 715 is actuated, the pump 714 and the valves 742, 753, 757 are switched off, and the valves 754, 755, 758 are switched to suitable positions to permit the reacted first liquid inside the accommodation space 110 of the regeneration container 11B1 to flow out of the accommodate space 110 via the first port 110a, to pass through the fourth filtration element 704, the guiding element 86, and the one-way valve 85, and then to flow back to the first tank 41. The regeneration process is completed after the backflow of the reacted first liquid is ceased. In addition, the pump 717 is actuated, the pump 716 and the valves 762, 763 are switched off, and the valves 764, 765 are switched to suitable positions to permit the accommodation liquid 111 in the third circulation path S3 to flow out of the accommodate space 110 of the regeneration container 11B2 via the first port 110a, to pass through the fifth filtration element 705, and the one-way valve 84, and then to flow back to the third tank 43. After the backflow of the accommodation liquid 111 in the third circulation path S3 is ceased, the electrodialysis process is completed, thereby obtaining a renewed container in which the ion-exchange resin 112 is active.

In summary, in the water softening apparatus 1 according to the present disclosure, the softening container 11A is capable of continuously converting the hard water into the soft water. After the ion-exchange resin 112 in softening container 11A becomes inactive (i.e., the softening container 11A becomes the regeneration container 11B), the inactive ion-exchange resin 112 can be regenerated by the regenerant salt using the regeneration system 4 of the water softening apparatus 1. With the provision of the water softening apparatus 1, complete recycling of the regenerant salt after regenerating of the inactive ion-exchange resin 112 can be conducted, thereby achieving zero emission of the regenerant salt.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A regeneration system for regenerating at least one regeneration container which has an accommodation space for confining therein an inactive ion-exchange resin, the regeneration system comprising:
a flow-path control device which is actuated to be operable in
a first circulation state, where an accommodation liquid inside the accommodation space is driven to continuously circulate through a first circulation path which passes through the accommodation space, and
a second circulation state, where the accommodation liquid is driven to continuously circulate through a second circulation path which passes through the accommodation space;
a first tank which is switchable to be in fluid communication with the accommodation space such that a first liquid inside said first tank is permitted to flow into the accommodation space to serve as the accommodation liquid and to be driven by said flow-path control device to continuously circulate through said first circulation path to force the first liquid to mix and react with the inactive ion-exchange resin that contains first cations, and such that after the first cations on the ion-exchange resin are exchanged with second cations to obtain a regenerated ion-exchange resin in a reacted first liquid, the reacted first liquid inside the accommodation space is permitted to flow back into said first tank;
a second tank which is switchable to be in fluid communication with said in first circulation path such that a second liquid, which has a regenerant salt containing the second cations in said second tank, is permitted to be introduced into said first circulation path to mix with the first liquid, and such that the first cations are permitted to react with the regenerant salt of the second liquid to obtain a resulting salt containing the first cations and to obtain the regenerated ion-exchange resin;
a first filtration element disposed to filter the first liquid in said first circulation path so as to collect a first portion of the resulting salt that is entrained in the first liquid;
a third tank which is switchable to be in fluid communication with the accommodation space such that after the reacted first liquid flows back into said first tank, a third liquid inside said third tank is permitted to be introduced into the accommodation space to serve as the accommodation liquid and to be driven by said first flow-path control device to continuously circulate through said second circulation path to force the third liquid to mix with the regenerated ion-exchange resin, and such that a second portion of the resulting salt, which remains inside the accommodation space, is permitted to be entrained in the third liquid and circulates through said second circulation path; and
a second filtration element disposed to filter the third liquid in said second circulation path so as to collect the second portion of the resulting salt entrained in the third liquid.

2. The regeneration system as claimed in claim 1, wherein:
said second circulation path includes a flow-out path portion for guiding the third liquid to flow out from the at least one regeneration container, and a flow-back path portion connected to said flow-out path portion at a first location for guiding the third liquid to flow back into the at least one regeneration container;
said flow-path control device is switchable to be operated in a third circulation state, where the accommodation liquid is driven to continuously circulate through a third circulation path which passes through the accommodation space, and the reacted first liquid inside said first tank is driven to continuously circulate through a fourth circulation path, said third circulation path including said second circulation path and a branch path portion, said branch path portion having two opposite ends, one of which is connected to said flow-out path portion at a second location, and the other of which is connected to said flow-back path portion at a third location, the first location being located between the second location and the third location, said fourth circulation path including a main path portion and a pass-through path portion which passes through an inner space of said first tank to interconnect a first end and a second end of said main path portion, said first end being proximate to an outlet of said first tank, said second end being proximate to an inlet of said first tank; and
said regeneration system further comprises an electrodialyzer that is disposed outside said first tank and that includes
a first chamber for passage of the third liquid flowing through said branch path portion of said third circulation path,
a second chamber for passage of the reacted first liquid in said main path portion of said fourth circulation path, and
an ion-exchange membrane disposed to separate said first chamber and said second chamber from each other such that when said flow-path control device is actuated to drive a remaining part of the regenerant salt that remains in the accommodation space and that is entrained in the third liquid to flow into said first chamber, the remaining part of the regenerant salt is forced by said electrodialyzer to pass through said ion-exchange membrane to flow into said second chamber and to flow along said fourth circulation path with the reacted first liquid.

3. The regeneration system as claimed in claim 2, further comprising:
a third filtration element disposed to filter the reacted first liquid in said main path portion of said fourth circulation path so as to collect a third portion of the resulting salt, which remains in the reacted first liquid.

4. The regeneration system as claimed in claim 2, further comprising:
a first pressure sensor unit disposed to detect a pressure difference of the third liquid before and after flowing through said first chamber; and
a second pressure sensor unit disposed to detect a pressure difference of the reacted first liquid before and after flowing through said second chamber.

5. The regeneration system as claimed in claim 2, wherein said flow-path control device is further switchable to be operated in a fourth circulation state, where the accommodation liquid is driven to continuously circulate through the third circulation path, and the reacted first liquid in said fourth circulation path is driven to continuously circulate through a fifth circulation path without passing through said inner space of said first tank, said fifth circulation path including said main path portion of said fourth circulation path, and a bypass path portion which is located outside said first tank to interconnect said first end and said second end of said main path portion.

6. The regeneration system as claimed in claim 1, further comprising:
a sensor unit provided to measure a concentration of the first cations of the first liquid in said first circulation path, such that the second liquid is introduced into said first circulation path in response to the concentration of the first cations being higher than a predetermined value.

7. A water softening apparatus for converting a hard water into a soft water, said water softening apparatus comprising:
said regeneration system as claimed in claim 1;
a container module including containers, each of said containers having an accommodation space for confining therein an ion-exchange resin,
a first selected one of said containers being coupled to a source of the hard water to serve as a softening container in which the ion-exchange resin is active so as to convert the hard water into the soft water,
a second selected one of said containers being coupled to said regeneration system to serve as said at least one regeneration container, in which the ion-exchange resin is inactive, so as to permit the ion-exchange resin inside said at least one regeneration container to be regenerated by said regeneration system.

8. The water softening apparatus as claimed in claim 7,
wherein after the ion-exchange resin in the first selected one of said containers becomes inactive, the first selected one of said containers serves as said at least one regeneration container,
wherein after the ion-exchange resin in the second selected one of said containers becomes active, the second selected one of said containers serves as said softening container, said water softening apparatus further comprising a connection module having
a first connector which is switchable to be coupled to said softening container,
a second connector which is switchable to be coupled to said at least one regeneration container, and
a retaining body which is configured to retain said first connector and said second connector thereinside, and which is turnable relative to said container module between
a first position, where said first connector is coupled to said first selected one of said containers which serves as said softening container, and said second connector is coupled to said second selected one of said containers which serves as said at least one regeneration container, and
a second position, where said first connector is coupled to said second selected one of said containers which serves as said softening container, and said second connector is coupled to said first selected one of said containers which serves as said at least one regeneration container.

9. The water softening apparatus as claimed in claim 8, wherein said first connector includes
a first passage configured to introduce the hard water into said accommodation space of said softening container so as to permit the hard water to be converted by the ion-exchange resin of said softening container into the soft water, and
a second passage configured to guide the soft water from said softening container to flow outwards.

10. The water softening apparatus as claimed in claim 7, wherein each of said containers includes an inner sensor which is configured to measure a hardness of the soft water, such that once said softening container is coupled to said first connector, said inner sensor of said softening container is in signal communication with said first connector, and such that said first connector is permitted to be detached from said softening container in response to the hardness of the soft water inside said softening container reaching a predetermined value.
